(19) United States
(12) Patent Application Publication
(10) Pub. No.: US 2006/0076539 A1
(43) Pub. Date: Apr. 13, 2006

(54) Bubble solution formula and method of manufacture

(76) Inventor: Wai Shun Wilson Lam, Kowloon (HK)

Correspondence Address: YING CHEN, 255 S. GRAND AVE., # 215, LOS ANGELES, CA, 90012, US

(21) Appl. No.: 11/135,916

(22) Filed: May 23, 2005

Related U.S. Application Data
(60) Provisional application No. 60/574,358, filed on May 24, 2004.

(51) Int. Cl. C11D 15/00

(52) U.S. Cl. 252/367.1

(57) ABSTRACT

An improved bubble solution for use with bubble blowing wands or toys and the method of manufacture is disclosed. The bubble solution contains water and functional amounts of EDTA-2Na, propylene glycol, lauryl betaine, a natural starch (such as Natrosol™ 250HHR), and a preservative (such as Phenova™). The bubble solution is made by: (1) heating de-ionized water in a mixing tank; (2) adding EDTA-2Na and the natural starch into the hot water and stirring until the solution is uniform; (3) mixing propylene glycol, lauryl betaine and the preservative in a separate container until uniformity is reached; and (4) pouring the solution from step (3) into the mixing tank while the water is still warm and the natural starch is dissolved. The bubble solution according to embodiments of the present invention produces more bubbles than presently available bubble formulas, using the same wand and same air pressure.

This is a regular patent application based on U.S. Provisional Patent Application No. 60/574,358 filed on May 24, 2004.

### FIELD OF THE INVENTION

The present invention relates to a bubble solution for use with bubble blowing wands or toys and the method of manufacture.

### DESCRIPTION OF THE RELATED ART

There is a constant demand for bubble blowing fluids to be used with toy bubble blowing wands or other bubble blowing toys such as bubble guns. Bubble solutions have been introduced that seek to have improved characteristics to the children playing with them. Typically the bubble solutions are a mix of soap and water. The child uses a wand consisting of a closed loop on a handle. The wand is dipped into the bubble blowing solution and then removed. The child then gently blows on the loop causing bubbles to be blown. In addition, there have also been numerous bubble blowing toys, some of which are battery operated for producing a constant stream of air.

While many bubble solution formulas are aiming for producing longer lasting bubbles, more colorful bubbles, large sized or more even sized bubbles, or bubbles are able to be touched without popping, the primary goal of bubble blowing solution manufacturers is still to simply make a bubble blowing solution that blows more bubbles. This is because one of the biggest selling feature of bubble solutions for repeat purchases by children is that when they use the bubble blowing solution, either by a conventional bubble blowing wand or by placing it into a bubble blowing gun or other machine, is that it blows the most bubbles.

### SUMMARY OF THE INVENTION

The present invention is directed to an improved bubble blowing solution formula and manufacturing method thereof.

It is an object of the present invention to provide a bubble blowing solution formula that can produce more bubbles when played by children with conventional bubble blowing toys.

It is another object of the present invention to provide a bubble blowing solution formula that can be used with either toy bubble blowing wands or other bubble blowing toys such as toy bubble guns.

It is an additional object of the present invention to provide a method of manufacture for producing an improved bubble blowing solution formula that can produce more bubbles when played by children with conventional bubble blowing toys including both toy bubble blowing wands and other bubble blowing toys such as toy bubble guns.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a bubble solution containing water and functional amounts of EDTA-2Na, propylene glycol, lauryl betaine, a natural starch (such as Natrosol™ 250HHR), and a preservative (such as Phenova™).

In another aspect, the present invention provides a method for making a bubble solution including: (1) heating de-ionized water in a mixing tank; (2) adding a natural starch (such as Natrosol 250HHR) and EDTA-2Na into the hot water and stirring until the solution is uniform; (3) mixing propylene glycol, lauryl betaine and a preservative in a separate container until uniformity is reached; and (4) pouring the solution from step (3) into the mixing tank while the water is still warm and the natural starch is dissolved.

It is to be understood that both the foregoing general description and the following detailed description are exemplary and explanatory and are intended to provide further explanation of the invention as claimed.

### DETAILED DESCRIPTION OF THE PREFERRED EMBODIMENTS

The present invention provides and improved bubble solution formula that produce more bubbles when played by children with either toy bubble blowing wands or other bubble blowing toys such as toy bubble guns.

According to an embodiment of the present invention, the following chemical compounds or materials are used in producing the bubble solution: EDTA-2Na, propylene glycol, lauryl betaine, a natural starch (such as Natrosol™ 250HHR), a preservative (such as Phenova™), and de-ionized water. These ingredients are used primarily for the following purposes in the bubble solution formula: EDTA-2Na is used to soften the water hardness by chelate the metals which may affect the performance of the bubbles. Propylene glycol is used to dilute the solution from being too thick to be released from the wand of the bubble blowing toy, and also serves the purpose of keeping the bubble film moist. Lauryl betaine is used to help form the bubbles while blowing. The natural starch (Natrosol 250HHR) is used to help build up the thickness of the bubble solution to form and hold the bubble film on the wand of bubble blowing toys. Phenova is used to preserve the solution from contamination. These ingredients should be present in the bubble solution in functional amounts, i.e., sufficient amounts to adequately perform their functions described above. De-ionized water is used so as to avoid the metal affect on the performance of the bubble formation.

Preferably, the composition of Phenova used in the bubble solution formula may include: 2-phenoxyethanol, methyl 4-hydroxybenzoate, ethyl 4-hydroxybenzoate, butyl 4-hydroxybenzoate, isobutyl 4-hydroxybenzoate, and propyl 4-hydroxybenzoate.

A method of manufacture of the bubble blowing solution according to embodiments of the present invention involves the following steps:

(1) Heating the de-ionized water in a mixing tank to a temperature of approximately 70 degrees C.

(2) Adding a natural starch (such as Natrosol 250HHR) into the hot water and stirring at a speed of about 300 rpm (but avoid the trapping of air).

(3) Adding EDTA-2Na into the stirring mixture until the solution is uniform. The order of adding the natural starch and EDTA-2Na is not important.

(4) Mixing propylene glycol, lauryl betaine and Phenova in a separate container until uniformity is reached.

(5) Pouring the solution from step (4) into the mixing tank while the water is still warm and the Natrosol 250 HHR is dissolved.

(6) Allowing the resultant mixture to cool down to room temperature around 25-30 degrees C.

In addition, the solution so produced may be examined for quality control.

In connection with the above described method of manufacture, the following equipment may be used for mixing and packaging the bubble solution: a mixing tank with heating and cooling device (such as a heater, and a cooling jacket); a stirring device with a speed of over 300 rpm; a thermometer for measuring the temperature of water and the mixture; a filling machine (preferably a piston pneumatic filling device) to fill the resulting solution in retail bottles (which preferably should be cleansed by using compressed dry air and sterilized by spraying 70% isopropyl alcohol solution and then evaporated for a proper time period in a dust free environment); a heater stamper or sealing machine for sealing the filled bottles with aluminum foil; and a labeling machine for labeling the bottles for retail sales after the filling and capping process. Of course, other appropriate equipment may be used in the alternative.

### EXAMPLE

In this example, a bubble solution according to a preferred embodiment of the present invention is made in accordance with the method described above and has the following ingredients (percentages are by weight of the final solution):

EDTA-2Na: approximately 0.05%;

Propylene glycol: approximately 1%;

Lauryl betaine: approximately 3%;

Natural starch (Natrosol 250HHR): approximately 0.5%;

Phenova: approximately 0.5%; and

De-ionized water: approximately 94.95%.

The Phenova used has the following composition (percentages are by weight of the Phenova):

2-Phenoxyethanol: >30%;

Methyl 4-hydroxybenzoate: 15-30%;

Ethyl 4-hydroxybenzoate: <5%;

Butyl 4-hydroxybenzoate: <5%;

Isobutyl 4-hydroxybenzoate: <5%; and

Propyl 4-hydroxybenzoate: <5%.

The de-ionized water is first heated in a mixing tank by a heater to a temperature of approximately 70 degrees C., then EDTA-2Na and Natrosol 250HHR are added (order not important) into the hot water and stirred with a stirrer at a speed of 300 rpm until the solution is completely uniform. Propylene glycol, lauryl betaine and Phenova are first fixed in a separate container until uniformity is reached, and then poured into the mixing tank while the water is still warm and the Natrosol 250 HHR is completely dissolved. The final solution is cooled down to room temperature around 25-30 degrees C. by running cold water through the cooling jacket of the mixing tank.

The resulting example solution is a non-toxic clear liquid, with a pH value at about 5.0 and a viscosity of approximately 260 cps, both measured at about 25 degrees C. When used together with a typical conventional bubble blowing wand in a normal manner, it was observed that more than 60 bubbles were formed from a single dipping of the wand in the example solution.

A visual test using existing bubble blowing solutions sold by Imperial Toy Corporation and Strombecker (any others) in the United States shows that using the same wands and the same blowing pressure, a bubble blowing solution according to embodiments of the present invention produces more bubbles than the Imperial or Strombecker bubble blowing solutions.

In addition to producing more bubbles, other advantages of the bubble solution formulas according to embodiments of the present invention include: an ability to produce more long lasting bubbles and more colorful bubbles, being safe and non-toxic for children to play with, and being easy and inexpensive to produce.

It will be appreciated that while the present invention has been described in detail with regards to the preferred embodiments, other variations in the formulations may be made or devised without departing from the inventive concept and scope of the present invention.

What is claimed is:

1. A bubble solution comprising water and functional amounts of EDTA-2Na, propylene glycol, lauryl betaine, and a natural starch.

2. The bubble solution of claim 1, further comprising a preservative.

3. The bubble solution of claim 1, wherein the natural starch is Natrosol 250HHR and the preservative is Phenova.

4. The bubble solution of claim 3, comprising approximately 0.05 wt. % EDTA-2Na, approximately 1 wt. % propylene glycol, approximately 3 wt. % lauryl betaine, approximately 0.5 wt. % Natrosol 250HHR, and approximately 0.5 wt. % Phenova.

5. The bubble solution of claim 3, wherein the Phenova includes a mixture of one or more of 2-phenoxyethanol, methyl 4-hydroxybenzoate, ethyl 4-hydroxybenzoate, butyl 4-hydroxybenzoate, isobutyl 4-hydroxybenzoate, and propyl 4-hydroxybenzoate.

6. The bubble solution of claim 5, wherein the Phenova includes greater than 30 wt. % 2-phenoxyethanol, approximately 15-30 wt. % methyl 4-hydroxybenzoate, less than 5 wt. % ethyl 4-hydroxybenzoate, less than 5 wt. % butyl 4-hydroxybenzoate, less than 5 wt. % isobutyl 4-hydroxybenzoate, and less than 5 wt. % propyl 4-hydroxybenzoate.

7. A method of making a bubble solution, comprising:
(1) heating de-ionized water in a mixing tank;
(2) adding a natural starch and EDTA-2Na into the hot water and stirring until the solution is uniform;
(3) mixing propylene glycol and lauryl betaine in a separate container until uniformity is reached; and
(4) pouring the solution from step (3) into the mixing tank while the water is still warm and the natural starch is dissolved.

8. The method of claim 7, further comprising:
(5) allowing the resultant mixture to cool down to room temperature.

9. The method of claim 7, wherein step (1), the water is heated to a temperature of approximately 70 degrees C.

10. The method of claim 7, wherein the stirring in step (2) is performed at a speed of about 300 rpm.

11. The method of claim 7, wherein in step (3), a preservative is mixed with propylene glycol and lauryl betaine.

12. The method of claim 11, wherein the natural starch is Natrosol 250HHR and the preservative is Phenova.

13. The method of claim 12, wherein
EDTA-2Na is added in an amount approximately 0.05 wt. % of the final solution, Natrosol 250HHR is added in an amount approximately 0.05 wt. % of the final solution, propylene glycol is added in an amount of approximately 1 wt. % of the final solution, lauryl betaine is added in an amount of approximately 3 wt. % of the final solution, and Phenova is added in an amount of approximately 0.5 wt. % of the final solution.

14. The method of claim 12, wherein the Phenova includes a mixture of one or more of 2-phenoxyethanol, methyl 4-hydroxybenzoate, ethyl 4-hydroxybenzoate, butyl 4-hydroxybenzoate, isobutyl 4-hydroxybenzoate, and propyl 4-hydroxybenzoate.

15. The method of claim 14, wherein the Phenova includes greater than 30 wt. % 2-phenoxyethanol, approximately 15-30 wt. % methyl 4-hydroxybenzoate, less than 5 wt. % ethyl 4-hydroxybenzoate, less than 5 wt. % butyl 4-hydroxybenzoate, less than 5 wt. % isobutyl 4-hydroxybenzoate, and less than 5 wt. % propyl 4-hydroxybenzoate.
